(19) United States
(12) Patent Application Publication
(10) Pub. No.: US 2009/0236349 A1
(43) Pub. Date: Sep. 24, 2009

(54) Pressure vessel

(75) Inventors: Dietmar Mueller, Herford (DE); Udo Burkheiser, Herford (DE)

Correspondence Address: Davidson, Davidson & Kappel, LLC, 485 7th Avenue, 14th Floor, New York, NY, 10018, US

(73) Assignee: XPERION GMBH, Herford (DE)

(21) Appl. No.: 12/310,986

(22) PCT Filed: Jul. 16, 2007
(86) PCT No.: PCT/EP2007/006096

§ 371 Date: Mar. 13, 2009

(30) Foreign Application Priority Data
Sep. 16, 2006 (DE) 10 2006 043 582.6

(51) Int. Cl. F17C 1/06

(52) U.S. Cl. 220/590; 220/589

(57) ABSTRACT

Pressure vessel for a pressurized medium which is capable of flow, providing a first reinforcement composed of fibers which are applied as a winding and which are embedded in synthetic resin, wherein in addition to the first reinforcement, a second reinforcement is provided, wherein said second reinforcement has an elongation at fracture which is lower than that of the first reinforcement, wherein the first reinforcement, considered alone, is sufficient to entirely absorb the forces resulting from the pressure of the medium in the pressure vessel, and wherein means are provided which are suitable for indicating a fracture of the second reinforcement.

This claims benefit of German Patent Application DE 10 2006 043 582.6, filed Sep. 16, 2006 through International Patent Application PCT/EP2007/006096, filed Jul. 16, 2007, both disclosures are hereby incorporated by reference herein.

The invention relates to a pressure vessel. Such pressure vessels are used for the storage of pressurized gaseous or liquid mediums.

### BACKGROUND

A pressure vessel of this type is known from DE 197 51 411 C1. It contains a blow molded plastic liner without significant rigidity which is externally enclosed by a reinforcement composed of fibers which are embedded in synthetic resin. The mentioned fibers are carbon fibers, aramid fibers, glass fibers and boron fibers as well as Al203 fibers and mixtures thereof. The different types of fibers have different characteristics and also different elongations at fracture. They are applied to the plastic liner in a manner similar to windings and embedded in a plastic matrix which may be composed of epoxy resin or phenolic resin or thermoplastics such as polyamide, polyethylene or polypropylene. All embodiments have in common that the thus obtained reinforcement has a rigidity sufficient to resist the forces resulting from a pressure load of the contained gas or liquid. The elongation at fracture depends particularly on the characteristics and the alignment of the respectively contained fibers. Overload may cause the pressure vessel to burst which entails significant risks consisting in that the pressure vessels burst suddenly and unpredictably, i.e. unforeseeably and uncontrollably, in the case of an overload. Due to this failure behavior the known pressure vessels are usually provided with a fiber composite reinforcement having relatively high safety factors. The vessels having a reinforcement made of fiber composite are therefore considerably oversized. Besides the use of pressure vessels with a reinforcement made of expensive high-strength carbon fibers, low-priced glass fibers are also employed. The fatigue strength of the glass fibers is less satisfying. The safety factors are therefore particularly high.

### SUMMARY OF THE INVENTION

An object of the invention is to manufacture such a pressure vessel in such a manner that overloads are indicated at an early stage and unforeseeable burst is prevented, while at the same time, the fatigue strength is improved and less material is required.

The present invention provides a pressure vessel for a pressurized, free-flowing or gaseous medium, comprising a first reinforcement composed of fibers which are applied as a winding and which are embedded in synthetic resin, characterized in that in addition to the first reinforcement, a second reinforcement is provided, in that said second reinforcement has an elongation at fracture which is lower than that of the first reinforcement, in that the first reinforcement, considered alone, is sufficient to entirely absorb the forces resulting from the pressure of the medium in the pressure vessel, in that an overload causes the second reinforcement to fracture, and in that the fracture of the second reinforcement will be noticeably indicated without the function of the first reinforcement being affected.

According to the invention, a second reinforcement is provided in addition to the first reinforcement, wherein the second reinforcement has an elongation at fracture which is lower than that of the first reinforcement, wherein the first reinforcement, considered alone, is sufficient to entirely absorb the forces resulting from the pressure of the medium in the pressure vessel, wherein an overload will cause the second reinforcement to fracture, and wherein the fracture of the second reinforcement will be visibly indicated without the function of the first reinforcement being affected.

At normal operating pressure, the second reinforcement may be effective parallel to the first reinforcement, thus reducing the load on the first reinforcement and effecting an improved fatigue strength as well as a lower weight of the first reinforcement. The elongation increases gradually, parallel to the height of the pressure of the fed medium. Since the elongation at fracture of the second reinforcement is lower than that of the first reinforcement, an overload of the pressure vessel causes firstly only a fracture of the second reinforcement. The overall load is then transmitted to the first reinforcement which is sufficient rigid to absorb the load alone. Such a fracture is always associated with an erratic elongation and a noticeable change in appearance of the pressure vessel which can be indicated by different means.

A fracture of the second reinforcement may be easy to visually recognize. The means can be therefore constituted by the second reinforcement itself. It may be provided that the pressure vessel is covered with a coat of paint whose color, for control purposes, is in contrast to the color of the second reinforcement to make a possibly very fine fracture better recognizable.

Alternatively, an electrically, mechanically or optically effective signal transmitter may be used to easily and reliably detect a fracture.

According to the invention, this can be utilized to avert the threatening danger of burst of the pressure vessel in good time before such an incident happens, e.g. by electrically or mechanically shutting off and/or emptying the pressure vessel. Thus, the occurrence of a fracture in the second reinforcement is not associated with a risk. There is therefore no fear that components of the contained medium, which is usually a pressurized gas or a liquid, will escape in an uncontrolled manner.

In line with the invention, the signal received in the case of a fracture of the second reinforcement can be used as an indicator to inhibit the further use of the pressure vessel or to allow the contained medium to escape in a directed and controlled manner. The pressure vessel must then be taken out of service and replaced by a new pressure vessel. The timely indication of overload is an important safety aspect with regard to the storage pressures of up to 700 bar used in hydrogen storage, for example. The operator will be provided with a “fail-safe-behavior”, i.e. despite of a local, controllable and determinable failure, the system remains altogether functional and reliable. After the failure of the second reinforcement, a further increase in pressure up to the final burst pressure is theoretically possible but systematically avoided if electrical, mechanical and optical shutdown mechanisms are included in the function of the pressure vessel. Such automatic shutdown mechanisms can in particular cause a fully automatic emptying or stop of the pressure vessel.

The second reinforcement has advantageously an elongation at fracture which is at most 90% of the elongation at fracture of the first reinforcement, preferably 50 to 70% of the elongation at fracture of the first reinforcement. This ensures that the second reinforcement fails noticeably earlier than the first reinforcement and that the failure of the second reinforcement does not entail any damage to the first reinforcement. The different elongations at fracture of the reinforcements are matched with each other, preferably by a targeted selection of materials and in particular in that the fibers possibly contained in the first reinforcement have a higher elongation at fracture than those contained in the second reinforcement.

Alternatively, the required different elongations at fracture of the reinforcements can be obtained in a constructive way, for example in that the first and the second reinforcement contain the same fibers and that the fibers of the first reinforcement which are arranged in a cylindrical area of the pressure vessel define an angle with respect to the axis of the pressure vessel which is smaller by at least 20°, advantageously by at least 30°, than that of the fibers of the second reinforcement in the cylindrical area. Thus, the elongation at fracture of the second reinforcement is also smaller than that of the first reinforcement. The more the angular difference of the fibers in the two reinforcements increases, the more the elongation at fracture of the second reinforcement decreases. The fibers are generally arranged in crossing layers in the reinforcements and stuck together by the plastic matrix.

The second reinforcement has preferably a higher rigidity than the first reinforcement. This has the advantage that the load on the first reinforcement is significantly reduced during operation, thus improving the fatigue strength of the pressure vessel. The rigidity of the second reinforcement should be higher by at least 10% and advantageously by at least 50% so as to noticeably reduce the load on the first reinforcement. The rigidity of the second reinforcement is preferably many times higher than that of the first reinforcement.

According to an advantageous embodiment, it is provided that the first reinforcement consists of metal and has the shape of a deep-drawn and/or welded pressure vessel made of steel or another metal, for example. Such materials have a relatively low elongation at fracture. Considered alone, they may be used in manifold applications and are particularly easy to mount by means of commercially available screw connections. The second reinforcement can be easily fixed thereon, for example by a winding process with prestressed, synthetic resin impregnated fibers, followed by curing of the synthetic resin. With this construction, it is therefore not necessary to use a plastic liner in the interior.

It is of advantage if both reinforcements contain fibers which are applied as a winding and which are embedded in synthetic resin after being prestressed. Such a homogeneously constructed pressure vessel is particularly lightweight and resistant to various stresses.

The two reinforcements can be arranged in two or more layers one above the other. Said layers can pass over into each other or be mixed with each other. In this case, however, controlling the respective elongations at fracture of the individual reinforcements is relatively more difficult. This embodiment is therefore reserved to special cases.

Preferred use is made of an embodiment in which the second reinforcement externally encloses the first reinforcement. This embodiment allows fractures of the second reinforcement to be particularly easy to detect and to be used as an indicator.

According to another advantageous embodiment, it is provided that the first reinforcement externally encloses the second reinforcement. This embodiment has the advantage that the relatively brittle second reinforcement is additionally protected against possible mechanical damages by the more resilient first reinforcement.

The second reinforcement has advantageously a wall thickness which is 5 to 50% of that of the first reinforcement. In this range it is possible to achieve a significant improvement of the fatigue strength of the pressure vessel as well as a good indication of overloads.

The fibers constituting the reinforcements can be selected from the spectrum of the known fibers. This selection depends significantly on the mutual matching of the elongations at fracture of the first and the second reinforcement according to the object of the patent application. It has been proved to be advantageous to employ metal fibers, carbon fibers, glass fibers, aramid fibers, pitch fibers, polyester fibers and/or basalt fibers.

Breakdowns are particularly easy and reliable to detect if the second reinforcement comprises a predetermined breaking point. In the case of an occurring overload, it will break exactly at this point and not in an area which is possibly very difficult to monitor. Thus, the used signal transmitter must be assigned to only this point and therefore it may be of small size and light weight.

It has been proved to be advantageous when the signal transmitter is suitable for emitting an electrical or mechanical control signal. Said control signal can be used, for example, to indicate a breakdown or to reroute the pressurized medium into another pressure vessel and/or to shutdown the pressure vessel and to allow the medium to escape from the pressure vessel in a directed manner.

### BRIEF DESCRIPTION OF THE DRAWINGS

An exemplary embodiment of the invention is shown in the enclosed drawings. It will be described later.

FIG. 1 shows a schematic view of a longitudinal section of a pressure vessel.

FIG. 2 shows a diagram which illustrates the elongations occurring during the intended use of the pressure vessel of FIG. 1 at different pressure stages.

### DETAILED DESCRIPTION THE INVENTION

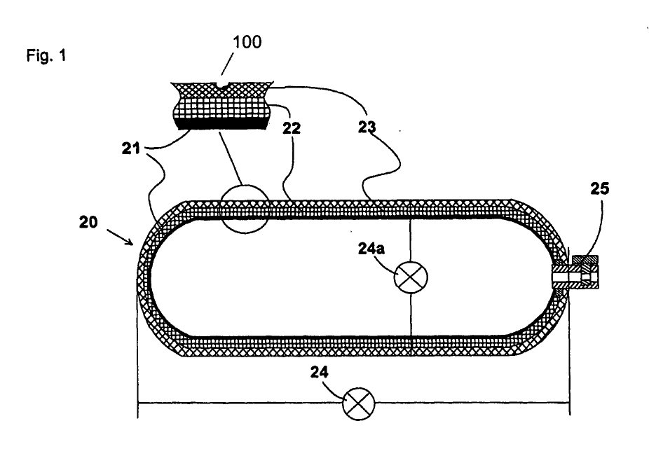

FIG. 1 shows a pressure vessel 20 for a pressurized medium 25 which is capable of flow, comprising a liner 21 arranged in its interior and having the shape of a blow molded hollow body or a rotational molded hollow body made of plastic, here made of a thermoplastic material, which is externally enclosed by a first reinforcement 22, said first reinforcement 22 in turn being externally enclosed by a second reinforcement 23 which is placed in layers on it. In addition, connecting elements 25, which may correspond to the state of the art, are provided for the supply of a pressurized medium.

The first reinforcement 22 includes glass fibers which are applied as a winding and which are embedded in synthetic resin. The fibers are wound as synthetic resin impregnated, mechanical prestressed fiber strands onto the liner 21. The number of windings and the type and thickness of the fibers as well as the selection and the curing of the synthetic resin may correspond to known standards, but in principle, they depend on the requirements of each individual case. The thickness of the first reinforcement 22 may be significantly reduced compared to the one-layer constructions of the state of the art because it is no longer necessary to include the previous enormous safety margins. Instead of these safety margins that entail a considerable weight increase the second reinforcement is employed which partially reduces the load on the first reinforcement and has the important function of an indicator in the case of an overload and has therefore a significantly reduced weight.

In addition to the first reinforcement 22, a second reinforcement 23 is provided whose structure and mounting are similar to that of the first reinforcement 22. The radial thickness of the second reinforcement 23 is about 10% of the thickness of the first reinforcement 22. Only the first reinforcement 22 has a load capacity sufficient to resist the forces resulting from the medium contained in the pressure vessel 20 on its own.

Furthermore, the second reinforcement 23 differs from the first reinforcement in that it has an elongation at fracture which is lower than that of the first reinforcement 22. In the case of an overload of the pressure vessel with a continuous increase in pressure, the first reinforcement 22 will thus always break delayed in time compared to the second reinforcement 23. It may also consist of metal, for example deep-drawn steel. Preferably, glass or basalt fibers are employed in the first reinforcement and carbon fibers are employed in the second reinforcement. The rigidity of the carbon fibers of the second reinforcement 23 is higher by the factor three than that of the glass fibers of the first reinforcement 22. In this example, the load on the first reinforcement 22 is therefore significantly reduced.

Moreover, the pressure vessel 20 is equipped with a signal transmitter 24 which is at lest capable of indicating a fracture of the second reinforcement 23. In the embodiment of FIG. 1, it consists of a tension sensor 24 which connects the opposing ends of the pressure vessel 20. Alternatively, it may be arranged in circumferential direction, reference 24a, and only reacts to a fracture of the second reinforcement, i.e. to the then expected controlled and erratic elongation change.

In the pressure vessel 20 of FIG. 1, both reinforcements 22, 23 consist of fibers which are applied as a winding in layers one above the other and which are embedded and integrated in synthetic resin.

The second reinforcement may have a predetermined breaking point 100 so as to spatially delimit the area where an overload causes a fracture. Said predetermined breaking point may also be formed by an indentation in the second reinforcement 22.

The signal emitted in the case of a fracture of the second reinforcement may be an electrical, optical or mechanical control signal adapted to shutdown the pressure vessel 20 and/or to allow the contained medium to escape from the pressure vessel in a controlled manner.

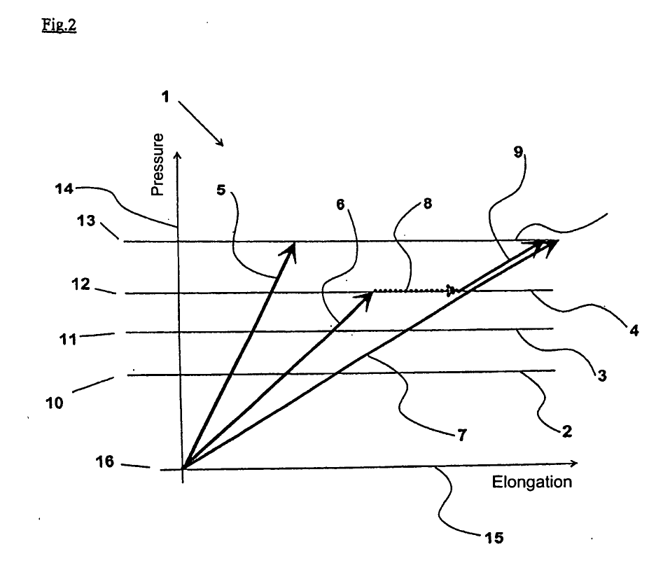

The function of the invention is further illustrated by the diagram of FIG. 2. In this diagram, the pressure is plotted against the elongation. The pressure scale 14 indicates the pressure of the liquid or gaseous medium contained in the pressure vessel 20. The elongation scale 15 indicates the elongation of the reinforcements 22 and 23 enclosing the pressure vessel 20, which results from the pressure in the pressure vessel. The pressure scale 14 comprises pressure stages. The pressure stage 16 designates the unpressurized application, the pressure stage 10 the operating pressure (e.g. 200 bar), and the pressure stage 13 the burst pressure (e.g. 500 bar).

The curve 5 in the diagram illustrates the progression of elongation during continuous increase in pressure in a pressure vessel which only consists of the second reinforcement 23 which in this case only contains carbon fibers. The curve 7 illustrates the progression of elongation of a pressure vessel which only consists of the first reinforcement 22 which in this case only contains glass fibers.

The pressure vessel according to the invention, however, comprises a combination of the first and the second reinforcement which are designed as described above and arranged in layers enclosing each other. All in all, it results a progression of elongation of the ready-for-use pressure vessel according to the curve 6 up to the pressure stage 12.

If the pressure in the interior of the pressure vessel 20 continues to increase beyond the pressure stage 12, the second reinforcement 23 which only contains carbon fibers will be the first to break because of the lower elongation at fracture at stage 12. The fracture induces an erratic elongation change 8 of the pressure vessel 20 with still undamaged reinforcement 22. This elongation change 8 is mechanically or electrically indicated by the signal transmitter 24 to allow the pressure vessel 20 to be shutdown. During this time, the still undamaged first reinforcement 22 alone is capable of absorbing the forces prevailing in the pressurized medium in the pressure vessel 20 without the pressure vessel 20 bursting or leakages occurring. Accordingly, the curve 8 develops which indicates the thus occurring and easily recognizable elongation changes of the pressure vessel 20. If the pressure further increases, the now missing second reinforcement 23 entails an increased elongation 9 in relation to the increase in pressure and finally a definitive failure at the previously calculated burst pressure when the pressure stage 13 is reached.

The dimensions of the first and the second reinforcement 23, 22 depend significantly on the respective application.

The test pressure 11 is above the operating pressure 10 and is generally agreed with the purchaser of such a pressure vessel or with the approval authorities.

In the context of the invention, the indication stage 12 is of particular importance: It indicates a controlled breaking of only the second reinforcement at a pressure even higher than the test pressure 11 and serves according to the invention as an indicator that the pressure vessel 20 has experienced an overload and has to be shutdown or emptied in time. An uncontrolled burst without prior warning is therefore impossible.

The burst pressure 13 at which the entire pressure vessel 20 is destroyed is even higher. In practice, this value cannot be reached during the use of the pressure vessel according to the invention thanks to the shutdown mechanism. However, it can be defined in the delivery specification so as to provide the purchaser with more certainty about the intended uses. A certain distance must be provided between the pressure stage 12 and the pressure stage 13 to prevent damages affecting the proper function of the first reinforcement 22 in the case of a controlled breaking of the second reinforcement 23.

In principle, this effect will also be achieved if the reinforcement is constructed in reversed order of the layers, i.e. if the first reinforcement externally encloses the second reinforcement. This embodiment has the advantage that the relatively brittle second reinforcement is additionally protected against possible mechanical damages by the more resilient first reinforcement. In this case, possible fissures in the second reinforcement may be detected visually by means of the resulting shape changes of the first reinforcement, as described above, or using secondary indicators, for example resistance meters, expansion strips, etc.

The advantages of the invention reside in particular in that, on the one hand, very little material is required for the manufacture of the pressure vessel which results in a reduced weight and, on the other hand, an uncontrolled burst is absolutely impossible so that the achieved safety level is higher than ever.

1-17. (canceled)

18: A pressure vessel for a pressurized, free-flowing or gaseous medium, comprising:
a first reinforcement composed of fibers applied as a winding and embedded in synthetic resin; and
a second reinforcement having an elongation at fracture lower than that of the first reinforcement, the first reinforcement, considered alone, being sufficient to entirely absorb forces resulting from pressure of the medium in the pressure vessel, in that an overload causes the second reinforcement to fracture, and in that the fracture of the second reinforcement will be noticeably indicated without the function of the first reinforcement being affected.

19: The pressure vessel according to claim 18 wherein the second reinforcement has an elongation at fracture which is at most 50 to 90% of the elongation at fracture of the first reinforcement.

20: The pressure vessel according to claim 18 wherein the second reinforcement has a rigidity which is higher by at least 10% than that of the first reinforcement.

21: The pressure vessel according to claim 18, wherein the second reinforcement has an elongation at fracture which is at most 50 to 70% of the elongation at fracture of the first reinforcement.

22: The pressure vessel according to claim 18, wherein the first reinforcement includes a deep-drawn and/or welded sheet metal.

23: The pressure vessel according to claim 18, wherein the second reinforcement contains further fibers applied as a further winding and embedded in further synthetic resin.

24: The pressure vessel according to claim 18, wherein the first and second reinforcements are arranged in layers one above the other.

25: The pressure vessel according to claim 18, wherein the first reinforcement externally encloses the second reinforcement.

26: The pressure vessel according to claim 18, wherein the second reinforcement externally encloses the first reinforcement.

27: The pressure vessel according to claim 23, wherein the second reinforcement has a wall thickness which is 5 to 50% of the wall thickness of the first reinforcement.

28: The pressure vessel according to claim 23, wherein the first and the second reinforcement contain the same fibers and that the fibers of the first reinforcement which are arranged in a cylindrical area of the pressure vessel define an angle with respect to the axis of the pressure vessel which is smaller by at least 20° than that of the further fibers of the second reinforcement in the cylindrical area.

29: The pressure vessel according to claim 23, wherein the fibers and further fibers have different elongations at fracture.

30: The pressure vessel according to claim 23, wherein the vessel is suitable for a visualization of an erratic change in appearance and/or the elongation of the wall of the pressure vessel.

31: The pressure vessel according to claim 18 further comprising a signal transmitter for detecting the elongation of the wall of the pressure vessel.

32: The pressure vessel according to claim 18, wherein the second reinforcement has a predetermined breaking point.

33: The pressure vessel according to claim 31 wherein the signal transmitter is suitable for emitting an electrical or mechanical control signal.

34: The pressure vessel according to claim 33, wherein the control signal is suitable for shutting down the pressure vessel.
